(19) United States
(12) Patent Application Publication
(10) Pub. No.: US 2022/0080701 A1
(43) Pub. Date: Mar. 17, 2022

(54) BIODEGRADABLE FABRICS MADE FROM POLYLACTIC ACID (PLA) FIBERS AND/OR YARNS AND METHODS FOR MAKING THE SAME

(71) Applicant: Kwok Shing Thomas Wong, Shatin (HK)

(72) Inventors: Adeel ZULIFQAR, Shatin (HK); Wai Yee CHUNG, N.T. (HK); Ishaq AHMAD, Shatin (HK); Wai Lin CHUNG, Shatin (HK); Polly Hang Mei LEUNG, Kowloon (HK); Jianzhen Li, Shatin (HK); Li Li, Kowloon (HK); Chi Luen Timothy WONG, Shatin (HK); Kwok Shing Thomas WONG, Shatin (HK)

(21) Appl. No.: 17/019,227

(22) Filed: Sep. 12, 2020

(51) Int. Cl. B32B 5/26; B32B 5/02; D03D 11/00; B01D 39/08

(52) U.S. Cl. CPC B32B 5/26; B32B 5/024; D03D 11/00; B01D 39/083; B01D 2239/0668; B32B 2307/7163; B01D 2239/0266; B01D 2239/0613; B01D 2239/065; B32B 2262/0276

(57) ABSTRACT

The present application relates to biodegradable and ecofriendly fabrics and methods for making the same. The fabrics are made from PLA fibers and/or yarns, and have one-way or two-way filtration characteristics and/or moisture management characteristics with controlled porosity and smooth or textured surface, the moisture management characteristics arise from a combined effect of material properties and fabric structure.

### TECHNICAL FIELD

The present application relates to a technical field of textiles, and particularly to woven fabrics that exhibit biodegradability, and good properties of one-way or two-way filtration, absorbency, breathability, quick drying and moisture management, and can be used as membranes in place of non-woven and foam materials, and methods for making the same.

### BACKGROUND

Moisture management of a fabric refers to a specific function related to dealing with unwanted moisture that come out of human body (perspirations) during any activity. Moisture management means that when moisture come in contact with the fabric, it should be taken away from skin and dried out as quickly as possible and the fabric in contact with skin should not produce any uncomfortable feeling because of the dampness. Moisture management of textiles largely depends on the moisture regain of fiber, fiber type and the structure of the fabric.

Moisture regain is defined as the percentage of water present in a textile material of oven dry weight. Generally, the fibers with lower moisture regain have better wicking and moisture management properties for example polyester, polypropylene, nylon etc. On the other hand, the fibers with higher moisture regain have poor moisture management properties like cotton. However, there are some exceptions like wool fiber, having higher moisture regain but still better moisture management properties especially in terms of quick drying features. In terms of fabric structure, it is claimed that fabrics with more open structure has better breathability and moisture management as compared to more dense and closed structures.

The fabrics which are mostly used for next to skin application areas require good moisture management properties in terms of drying rate. The quick dry performance of a fabric refers to the high speed at which the wetted fabric can be dried again through two-way transportation, including wicking, absorbency, and breathability. Wicking means the ability of a fabric to make moisture to be wicked or siphoned away from the skin while the absorbency is the property of a fabric to draw the moisture outside to keep the skin dry and quick drying ability means the rate of evaporation of moisture into air. Breathability or water vapor permeability indicates how quickly moisture from the human body during activity can be transferred into the air by textiles. The better permeability of the clothing, the more comfortable it is to wear.

In order to obtain more of the above mentioned properties, a method known to the inventor(s) is that, different kinds of textile materials for making of next to skin garment are used in combination to achieve a desired effect. These materials may include traditional waddings or nonwovens, advanced thermal insulating materials like Thermore® nonwovens, or membrane systems like Gore-Tex®, Windstoper®, Sympatex®, Porelle®, Permatex®, Osmosis® Dry Tex, etc.

### SUMMARY

One embodiment of the present application provides a biodegradable and ecofriendly single layer or multi-layer fabric, the fabric is made from PLA fibers and/or yarns, and has one-way or two-way filtration characteristics and/or moisture management characteristics with controlled porosity and smooth or textured surface.

Another embodiment of the present application provides a method for making a biodegradable and ecofriendly single layer or multi-layer fabric, the method includes using a combination of PLA yarns, staple PLA yarns, filament PLA yarns or combinations of both yarns and/or PLA yarns as warp yarn, weft yarn or both to make the fabric, and the fabric has one-way or two-way filtration characteristics and/or moisture management characteristics with controlled porosity and smooth or textured surface.

### BRIEF DESCRIPTION OF THE DRAWINGS

FIG. 1 is an illustration of retention sites and filtration in a biodegradable and ecofriendly textured fabric filter with inter yarn and intrafibers porosity and stagnation zones;

FIG. 2 is a photo of a biodegradable and ecofriendly, single layer woven fabric structure with textured surface made from multifilament PLA yarns;

FIG. 3 is a photo of a biodegradable and ecofriendly, continuously integrated two-layer woven fabric structure with smooth surface made from staple PLA yarns;

FIG. 4 is a photo of a biodegradable and ecofriendly, intermittently integrated two-layer woven fabric structure with textured surface made from staple PLA yarns and multifilament PLA yarns combination;

FIG. 5 is a photo of a biodegradable and ecofriendly, intermittently integrated three-layer woven fabric structure with textured surface made from staple PLA yarns;

FIG. 6 is a photo of a biodegradable and ecofriendly, continuously integrated three-layer woven fabric structure with smooth surface made from staple PLA yarns;

FIG. 7 is a photo of a biodegradable and ecofriendly, intermittently integrated three-layer woven fabric structure with textured surface made from staple PLA yarns and multifilament PLA yarns combination;

FIG. 8 is a schematic diagram of a biodegradable and ecofriendly, continuously or intermittently integrated four-layer woven fabric structure made from staple and/or multifilament PLA yarns.

### DETAILED DESCRIPTION

Whereas the present application has been described with reference to one or more examples, it will be assumed by those skilled in the art that numerous modifications might be designed and counterparts may be relieved for components thereof without departing from the scope of the present application. Moreover, many modifications might be designed to adapt a particular feature or material to the teachings of the application without departing from the scope of this application. Consequently, it is envisioned that the present application not be restricted to the particular example revealed as the best methods considered, but that the application will include all examples falling within the scope of the added claims.

Furthermore, all technical and scientific terms used herein denote the meaning as commonly understood by those skilled in the art throughout the specification. As used herein, the term “and/or” used in the specification includes any and all combinations of one or more of the associated listed items.

The presented application encompasses a research work concerning the moisture management properties and one-way or two-way filtration characteristics of woven fabrics, although currently numerous available systems can be used for moisture management applications, the fabrics or devices and methods for making them have certain limitations as explained below.

In making of the existing fabrics or devices, mostly non-biodegradable polyester and nylon fibers are used, which makes them non-biodegradable and they results in solid waste. Furthermore, it has been established that micro fibrillation of such synthetic fibers during laundry ends up in oceans and is a serious threat not only for marine life but also for humans via sea food consumption.

The fabric making technique particularly for multi-layer woven fabrics has limited design flexibility. For example, tacking technique is used to join the two fabric layers in a square fashion with creation of air gaps that provides better insulation. However, such a structure is not good for moisture absorbency followed by moisture transport, which requires two layers of the multi-layer woven fabrics to be integrated or joined very closely to each other, so that the moisture can be absorbed and quickly transported by inner layer to the outer layer in order to allow quick drying.

In making of the existing fabrics or devices, non-woven or foams are mostly used as membranes for moisture absorbency. These membranes are required to be attached with the garment separately adding to the cost, which makes the garment making more expensive, therefore, these are used mostly for high-performance applications.

The higher thickness of these fabrics and poor formability of devices with foams and non-woven membranes restrict their incorporation into the next to skin clothing applications and they are mostly used for outerwear.

The woven fabrics are not capable of dealing with a few of moisture management features presented in the background at the same time. For example, if a woven fabric is good in terms of absorbency it may lack the wicking, breathability, water vapor permeability and quick dry feature. On the other hand, if a woven fabric is very breathable with better wicking, the absorbency and quick drying ability of that fabric are poor.

The low air permeability of high density or multi-layer woven fabric structures is a barrier to attain good moisture management properties, which could cause undesirable accumulation of moisture inside.

Most of the fabrics and devices cannot be used for air and/or particle filtration.

Therefore, there exists a need for a biodegradable and ecofriendly woven fabric, made of natural and biodegradable fibers and/or yarns, a woven fabric that can provide better one-way or two-way filtration characteristics, the layers of which can be bonded together into a multi-layer structure by quick and efficient ultrasonic heating or sealing which can be used in applications requiring heating or sealing of different layers, a woven fabric that can be used with or without ultrasonic heat bonding as membrane in place of non-woven and foam materials, and a woven fabric with retention of functionality after repeated use.

In addition, a woven fabric with better moisture management properties including better absorbency wicking, breathability, water vapor transmission, and quick dry features together with anti-odor, anti-fungal, and UV resistant features, therefore, an ecofriendly and biodegradable woven fabric which has a broader application spectrum.

The inventor(s) discovered that PLA is a new class of natural material obtained from renewable crops in the process of implementing the present application. Therefore, woven fabrics made of PLA with specialized weaving structures are a new class of textile architectures that can provide a biodegradable thus an ecofriendly fabric. Additionally, with the inherent anti-microbial resistance of PLA and the moisture management capacity of the fabrics, which can shorten the life span of bacteria and viruses and be further strengthened by multifunctional coatings and/or through manipulation of fabric structures in different layers these fabrics can be used as one-way or two-way filtration media.

Furthermore, PLA fiber is a thermoplastic biomaterial and therefore, the layers of provided fabrics can be bonded together into a multi-layer structure by quick and efficient ultrasonic heating or sealing. Such fabrics can be used with or without ultrasonic heat bonding or sealing as membrane in place of non-woven and foam materials. Furthermore, PLA has better moisture management properties including better wicking, breathability, water vapor transmission, absorbency and quick dry features at the same time together with anti-odor, anti-fungal, and UV resistant features.

Therefore, because of their unique characteristics, better moisture management properties as mentioned above, lower thickness and better formability, these fabrics could be used in next to skin clothing applications and membranes especially in healthcare, sportswear and personalized wear. In addition to their unique characteristics, these fabrics have better formability which makes them highly flexible material that can be easily shaped into garment parts for next to skin clothing and outer wear applications.

In view of the above mentioned characteristics, the present application relates to one or more biodegradable and ecofriendly single layer and multi-layer woven fabrics made from biodegradable PLA fibers and/or yarns and methods for making the same.

Wherein the single layer and multi-layer woven fabrics have better moisture management properties including better absorbency, wicking, anti-odor, anti-fungal, breathability, water vapor transmission, and quick dry features at the same time together with proven biodegradability and UV resistance.

Additionally, with the inherent anti-microbial resistance of PLA, the fabrics of the present application can shorten the life span of bacteria and viruses and be further strengthened by multifunctional coatings and/or through manipulation of fabric structures in different layers.

Furthermore, the fabrics of the present application can be used as one-way or two-way filtration media, and capable of overcome, improve and/or lessen one or more of the above-mentioned deficiencies and shortcomings of conventional woven fabrics and methods for fabrication of such fabrics.

The structure and manufacturing method of the fabrics of the present application are described in detail below.

One fabric includes a single layer or multi-layer woven fabric structure of natural biodegradable PLA fibers and/or yarns, and the single layer and multi-layer woven fabrics are fabricated by using a combination of PLA yarns, staple PLA yarns, filament PLA yarns or combinations of both yarns and/or PLA yarns made from any known yarn making techniques including but not limited to ring spinning, rotor spinning, friction spinning, melt spinning, air jet spinning to make a single layer or multi-layer woven fabric.

Specifically, the single layer and multi-layer woven fabrics may be fabricated by using any or combinations of warp yarns from a combination of PLA yarns, staple PLA yarns, filament PLA yarns or combinations of both yarns and/or PLA yarns made from any yarn making techniques including but not limited to ring spinning, rotor spinning, friction spinning, melt spinning, air jet spinning or yarns made from any other yarn making technique.

And, the single layer and multi-layer woven fabrics can also be fabricated by using any or combinations of weft yarns from a combination of PLA yarns, staple PLA yarns, filament PLA yarns or combinations of both yarns and/or PLA yarns made from any yarn making techniques including but not limited to ring spinning, rotor spinning, friction spinning, melt spinning, air jet spinning or yarns made from any other yarn making technique.

And, the multi-layer woven fabrics can also be fabricated by using any or combinations of stitching yarns from a combination of PLA yarns, staple PLA yarns, filament PLA yarns or combinations of both yarns and/or PLA yarns made from any yarn making techniques including but not limited to ring spinning, rotor spinning, friction spinning, melt spinning, air jet spinning or yarns made from any other yarn making technique.

Thus, using any kind or combinations of the PLA yarns as warp yarn, weft yarn or both can fabricate biodegradable single layer and multi-layer woven fabrics having interlaced architectures of warp and weft, where the produced single layer and multi-layer fabrics have better one-way or two-way filtration characteristics, can be used with or without ultrasonic heat bonding or sealing of different layers as membrane in place of non-woven and foam material, have better moisture management properties and are capable of providing/creating optimized porosity and smooth or textured surface, which results from the combined effects of material properties and weaving structure and can be retained after repeated use.

For example, the single layer and multi-layer woven fabrics having interlaced architectures of warp and weft of any kind or combinations of the PLA yarns can be used with or without ultrasonic heat bonding or sealing in parts, in whole or in predesigned localized patterns as a woven membrane layer in place of non-woven or foam materials. Further, the single layer and multi-layer woven fabrics can be used as one-way or two-way filtration media.

Referring to FIG. 1, the combination of textured surface and controlled inter-yarns and/or intrafibers porosity of fabrics of the present application can create any of the filtration mechanisms including stagnation zone retention, absorption or straining, adsorption, interception, Brownian diffusion, inertial impaction, gravity, hydrodynamic effects and electrostatic attraction and/or any combination of these to achieve the function of one-way or two-way air and/or particle filtration for any given application, where the fabrics can be used as a pre-filter and/or a main filter and/or a post-filter and/or any combination of these. Furthermore, where the final filtration configuration of the fabrics can be dictated by the application, and the particular particle and/or contaminant that is being filtered.

The moisture management characteristics or feature of the single layer fabric, or feature of each layer in the multi-layer fabric can be any one or more or combinations of better absorbency, wicking, anti-odor, anti-fungal, breathability, water vapor transmission, and quick dry features at the same time together with proven biodegradability and UV resistance. Additionally, with the inherent anti-microbial resistance of PLA and the moisture management capacity of the invented fabrics, which can shorten the life span of bacteria and viruses and be further strengthened by multifunctional coatings and/or through manipulation of fabric structures in different layers these fabrics can be used as one-way or two-way filtration media.

As it is known that moisture management properties are important for thermo-physiological comfort. Therefore the single layer and multi-layer woven fabrics of the present application can be used for making outer wear and next to skin clothing applications that can be used in daily life as casual wear, healthcare including but not limited to incontinence management products, sanitary products, wound dressings and bandages of different kinds, particularly for diabetic foot ulcers, compression garment for varicose veins, face masks, surgical masks, masks for health services, masks for food and beauty care professionals, fashionable masks, respirators for industrial workers and general use, veils for burqa and hijab used by women and men, scarves, head covers, neck gaiters, neck covers, all kinds of sportswear, vests, pajamas, shirts, head bands, wrist bands, different kinds of straps as textile carriers for wearable healthcare devices, head gears, personalized wear including all kinds of undergarments for people of all ages and all genders and textiles for ageing.

The present application further provides a method for making the biodegradable and ecofriendly, single layer and multi-layer woven fabrics having interlaced architectures of warp and weft that is fabricated by using any of the fabrication technique and made of any kind or combinations of the PLA yarns used as warp, weft or both.

The method is to realize specialized structures as unit cell of woven structure which upon relaxation or removing from the weaving machine along one, two or three plane directions is capable of providing/creating smooth or textured surface, optimized porosity and breathability due to its architecture.

Advantageously, the single layer and multi-layer woven fabrics according to the present application can be woven on any commercially available conventional or advanced weaving machines with one or more than one warp beam option and one or more than one weft supplies option, such as any type of shedding mechanism, warp supply system including but not limited to single warp beam or twin warp beam and any weft insertion system. In addition, such biodegradable and ecofriendly single layer and multi-layer fabrics can be made by using weaving, braiding, weft knitting, warp knitting or non-woven technology.

In some embodiments, the fabrics having woven architecture according to the present application can be produced by dobby shedding mechanism. However, it should be recognized that the fabrics of the present application can be produced by any shedding mechanism such as, but not limited to Tappet, Dobby and Jacquard shedding mechanism.

And, the fabrics can be produced by rapier weft insertion system. However, it should be recognized that the fabrics of the present application can be produced by any weft insertion system such as, but not limited to air jet weft insertion system, projectile, shuttle, multiphase and water jet or magnetic weft insertion system.

Wherein, the single layer fabrics are fabricated by employing any of the basic weaving structures including plain, twill satin, sateen or any combination of basic weaves and/or dobby weave and/or fabricated by manipulation of warp yarn filling patterns and/or weft yarn filling patterns and/or manipulation of warp and weft linear densities and/or thread densities into the fabric structure in order to optimize the porosity or texture of the fabric.

Similarly, the multi-layer woven fabric structures are fabricated by employing any of the basic weaving structures including plain, twill satin, sateen or any combination of basic weaves and/or dobby weave and/or fabricated by manipulation of warp and weft yarn filling patterns and/or manipulation of warp yarn and/or weft yarn linear and/or thread densities into the fabric structure. In addition, the layers can be separated, integrated, intermittently integrated or continuously integrated produced by the techniques of multi-layer fabric including but not limited to centre-stitched, self-stitched, brocades, backed cloths, double cloth, treble cloths or interchanged fabric structure or any combination of these.

The multi-layer woven fabric structures can also be produced while the one fabric layer may have the same structure as the other fabric layer or have a different structure from the other layer, and may also have a symmetric structure or an asymmetric structure with another layer of fabric. It is understandable that, because the structure with the one-way or two-way filtration characteristics properties, membrane functions and moisture management characteristic are not unique, the structures of both the first layer and the second layer can have a plurality of choices.

In general, the biodegradable and ecofriendly single layer and multi-layer woven fabrics with better one-way or two-way filtration characteristics, better moisture management properties and that can be used as membrane in place of non-woven and foam materials are achieved by the combined properties of natural, biodegradable PLA yarns, specially designed weaving structure of warp and weft, the fabrication techniques and/or the manipulation of warp and/or weft filling patterns and/or the manipulation of warp yarn and/or weft yarn linear and thread densities into the fabric structure.

Thus, the fabrication techniques and/or the manipulation of warp and weft filling patterns and the manipulation of warp yarn and weft yarn linear and thread densities into the fabric structure are capable of making the structure breathable by controlling the porosity of the fabric, to provide better wicking characteristics to the fabric and the weaving structure of warp and weft. This combination of structural controlled porosity and better absorbency and wicking characteristics of PLA can be successfully exploited for several clothing applications. Moreover, the absorbency and wicking provide better moisture transport and the porosity results in breathability and quick drying feature.

The porosity and textured surface effect of the single layer and multi-layer fabrics can be achieved by any or combinations of fabric making techniques, weaving structures, manipulation of warp and weft yarn filling patterns, manipulation of warp yarn and weft yarn linear and thread densities in the fabric structure, and can be optimized or controlled to suit the end use application.

All in all, the present application has the following advantages.

Biodegradable and ecofriendly: the fabrics provided in the application are produced with natural and biodegradable PLA fibers and/or yarns and are therefore, biodegradable and ecofriendly. The fabrics of the present application would not end up in solid waste and would not be a threat to marine life because of micro fibrillation.

Ultrasonic heat bonding or sealing: PLA fiber is a thermoplastic biomaterial and therefore, the layers of provided fabrics can be bonded together into a multi-layer structure by quick and efficient ultrasonic heating or sealing.

One-way or two-way filtration and membrane: the fabrics of the present application have better one-way or two-way filtration characteristics and can be used with or without ultrasonic heat bonding or sealing as membrane in place of non-woven and foam materials as mentioned above for moisture absorbency followed by moisture transport in outer wear and next to skin clothing application.

Better moisture management: the present application provides biodegradable and ecofriendly, single layer and multi-layer woven fabrics with better moisture management properties, which result from the combined effects of material properties and weaving structure.

Versatility and flexibility: this present application provides versatility because there is no restriction on using a specific kind of yarns and any kind of yarns or combinations.

Lower thickness dimensional stability and formability: the present application provides woven fabrics which are more dimensionally stable, have lower thickness and better formability as compared to knitted fabrics, foams and non-woven fabrics.

Functional durability: the present application provides woven fabrics with outstanding retention of functionality after repeated use.

Broader application spectrum: because of lower thickness, better moisture management properties, better formability, versatility in choice of both yarn type and weaving structures, these fabrics have a broader application spectrum.

It will be understood by those skilled in the art that one or more facets of this application can meet certain objectives, while one or more other facets of this application can meet certain other objectives. Each objective may not apply equally in all its respects, to every facet of this application. As such, the following objectives can be viewed in the alternative with respect to any one facet of this application.

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, compositions, articles, thread densities, linear densities, number of layers, fabric widths, number of stitching yarns etc.), but some errors and deviations should be accounted for.

### Example 1: 1—Layer Fabric Providing Textured Surface

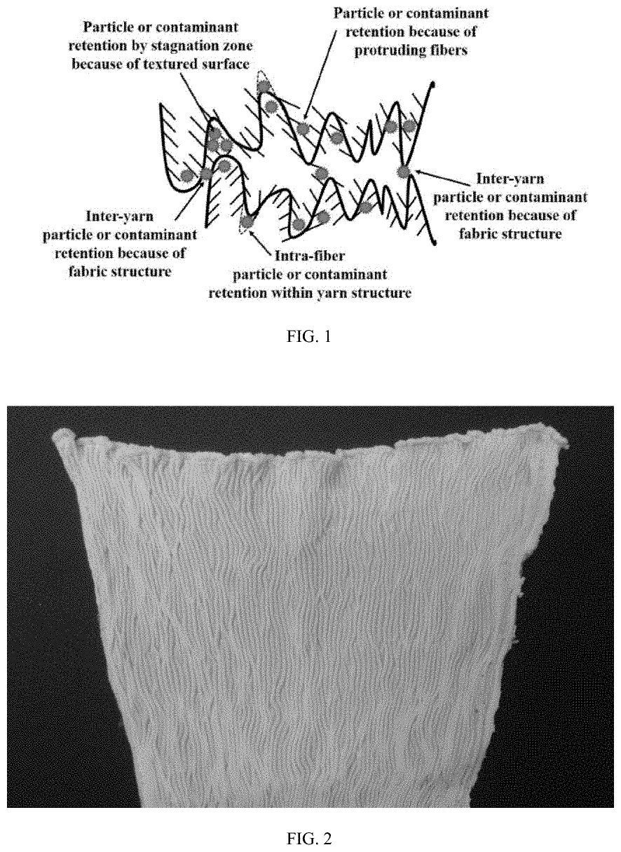

Referring to FIG. 2, aspects of the application relate to a biodegradable and ecofriendly single layer fabric with small porosity or large porosity and textured surface effect, which results in achieving or manipulation of better one-way or two-way filtration characteristics, better moisture management characteristics and can be used as membrane in place of non-woven and foam materials.

The warp and weft yarns are PLA multi filament yarns with a yarn size 150 Denier having 64 filaments. The fabric construction is a 1/1 plain weave with warp*weft thread density of 80*100, which can provide a textured surface after removing from the weaving machine.

### Example 2: 2—Layer Fabric Providing Smooth Surface

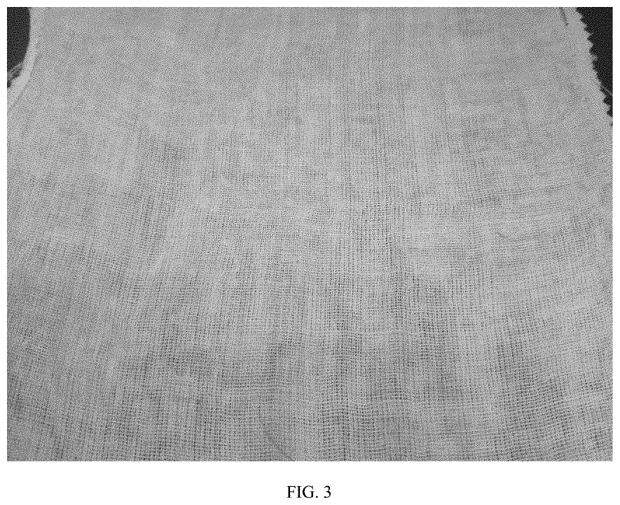

Referring to FIG. 3, aspects of the application relate to a biodegradable and ecofriendly two-layer fabric with better one-way or two-way filtration characteristics, better moisture management characteristics and can be used as membrane in place of non-woven and foam materials, including at least a first woven fabric layer and a second woven fabric layer. The first woven fabric layer provides a first characteristic or feature to the two-layer fabric, the second woven fabric layer provides a second characteristic or feature to the two-layer fabric, where the two characteristics or features are different from each other.

The fabric is a continuously integrated two-layer woven fabric structure with smooth surface. The warp and weft yarns are staple PLA yarns with a yarn size 40's Ne, the fabric has a warp*weft thread density of 90*70, which can provide a smooth surface after removing from the weaving machine.

### Example 3: 2—Layer Fabric Providing Textured Surface

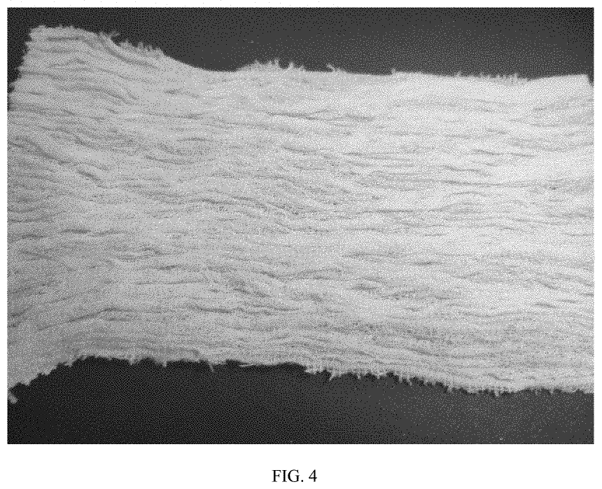

Referring to FIG. 4, the fabric in Example 3 differs from the fabric in Example 2 in that: the fabric in Example 3 is an intermittently integrated two-layer woven fabric structure with textured surface. The warp yarns are staple PLA yarns with a yarn size 40's Ne, and the weft yarns are staple PLA yarns with a yarn size 40's Ne and multifilament PLA yarns with a yarn size 150 Denier having 64 filaments in alternate fashion. The fabric has a warp*weft thread density of 90*70, which can provide a textured surface after removing from the weaving machine.

### Example 4: 3—Layer Fabric Providing Textured Surface

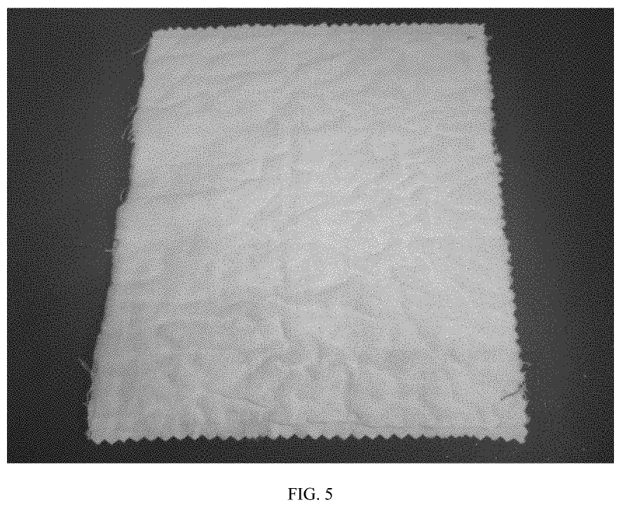

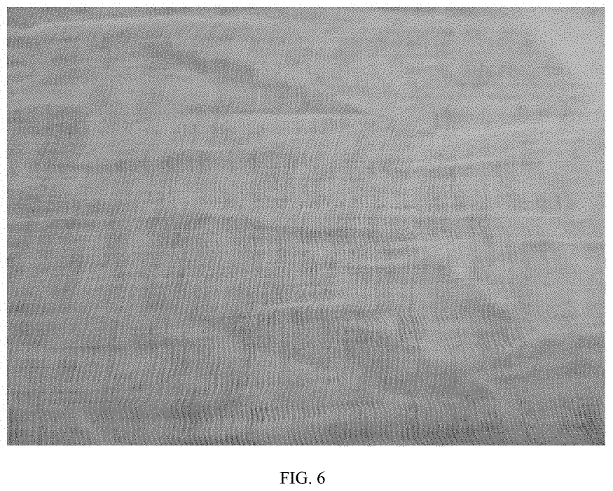

Referring to FIG. 5, aspects of the application relate to a biodegradable and ecofriendly three-layer fabric with better one-way or two-way filtration characteristics, better moisture management characteristics and can be used as membrane in place of non-woven and foam materials, including at least a first woven fabric layer, a second woven fabric layer and a third woven fabric layer. The first woven fabric layer provides a first characteristic or feature to the multi-layer fabric, the second woven fabric layer provides a second characteristic or feature to the multi-layer fabric and the third woven fabric layer provides a third characteristic or feature to the multi-layer fabric, where all the three characteristics or features are different from each other.

For example, the first layer may have better wicking function, antimicrobial activity and liquid droplet or moisture vapors permeable structure, the second may layer possess a super absorbent, quick dry and one-way or two-way filtration features while the third layer may have a porous therefore breathable structure to help evaporate moisture from the second layer quickly and efficiently.

The fabric is an intermittently integrated three-layer woven fabric structure with textured surface made of staple PLA yarns. The warp and weft yarns are staple PLA yarns with a yarn size 40's Ne, the fabric has a warp*weft thread density of 180*160, which can provide a textured surface after removing from the weaving machine.

### Example 5: 3—Layer Fabric Providing Smooth Surface

Referring to FIG. 6, the fabric in Example 5 differs from the fabric in Example 4 in that: the fabric in Example 5 is a continuously integrated three-layer woven fabric structure with smooth surface made of staple PLA yarns. The warp and weft yarns are staple PLA yarns with a yarn size 40's Ne, the fabric has a warp*weft thread density of 110*90, which can provide a smooth surface after removing from the weaving machine.

### Example 6: 3—Layer Fabric Providing Textured Surface

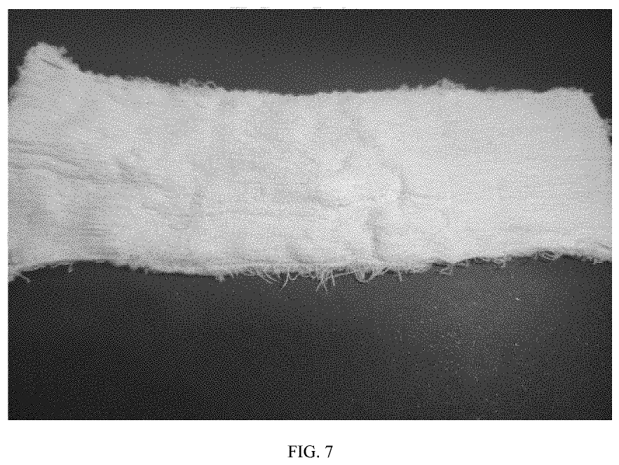

Referring to FIG. 7, the fabric in Example 6 differs from the fabric in Example 4 in that: the fabric in Example 6 is an intermittently integrated three-layer woven fabric structure with textured surface made of combination of staple PLA yarns and multifilament PLA yarns. The warp yarns are Staple PLA yarns with a yarn size 40's Ne, and the weft yarns are staple PLA yarns with a yarn size 40's Ne and multifilament PLA yarns with a yarn size 150 Denier having 64 filaments in alternate fashion. The fabric has a warp*weft thread density of 110*90, which can provide a textured surface after removing from the weaving machine.

### Example 7: 4—Layer Fabric Providing Smooth Surface

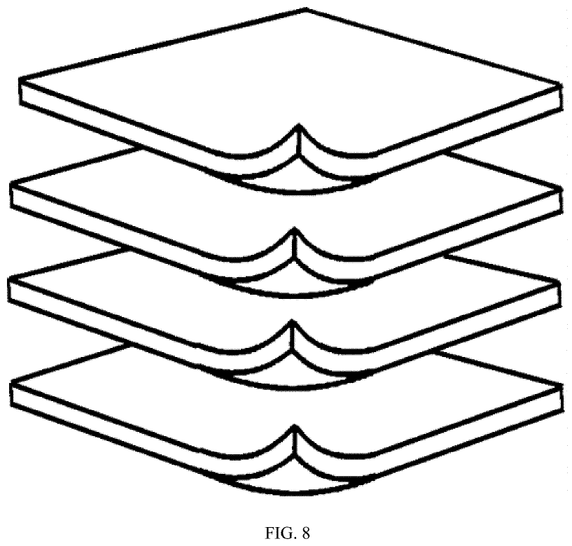

Referring to FIG. 8, aspects of the application also relate to a biodegradable and ecofriendly multi-layer fabric with better one-way or two-way filtration properties, better moisture management characteristics and can be used as membrane in place of non-woven and foam materials, including at least a first woven fabric layer, a second woven fabric layer, a third woven fabric layer and a fourth woven fabric layer. The first woven fabric layer provides a first characteristic or feature to the multi-layer fabric, the second woven fabric layer provides a second characteristic or feature to the multi-layer fabric, the third woven fabric layer provides a third characteristic or feature to the multi-layer fabric and the fourth woven fabric layer provides a fourth characteristic or feature to the multi-layer fabric, where all the four characteristics or features are different from each other.

This example describes an intermittently or continuously integrated four-layer woven fabric structure with smooth or textured surface made of staple and/or multifilament PLA yarns. For example, the warp and weft yarns are staple PLA yarns with a yarn size 40's Ne, and the fabric has a warp*weft thread density of 200*160, which can provide a smooth surface after removing from the weaving machine.

These and other objectives and advantages of the present application are provided by a biodegradable and ecofriendly single layer or multi-layer woven fabrics, including a woven architecture of natural and biodegradable PLA yarns, and having better moisture management properties achieved by the combined properties of biodegradable PLA yarns, and/or specially designed weaving structure of warp and weft, and/or the fabrication techniques and/or the manipulation of warp and/or weft filling patterns and/or the manipulation of warp yarn and weft yarn linear and thread densities into the fabric structure.

Finally, it should be noted that the above examples are intended only to illustrate the technical solutions of the present application, not to be limiting; the above embodiments or technical features in different embodiments may also be combined, the steps may be carried out in any order according to the idea of the present application, and many other variations in different aspects of the invention as described above exist, which are not provided in detail for the sake of brevity; although the present application has been described in detail with reference to the foregoing embodiments, those skilled in the art will appreciate that the technical solutions of the above embodiments can still be modified, or some of the technical features thereof may found their equivalents; and these modifications and equivalents do not render departures from the scope of the present embodiments of the invention.

1. A biodegradable and ecofriendly single layer or multi-layer fabric, made from polylactic acid (PLA) fibers and/or yarns and having one-way or two-way filtration characteristics and/or moisture management characteristics with controlled porosity and textured surface, wherein the multilayer fabric at least comprises a first woven fabric layer, a second woven fabric layer and a third woven fabric layer;
the first woven fabric layer has wicking function, antimicrobial activity and liquid droplet or moisture vapors permeable structure; the second woven fabric layer is absorbent, and has quick dry and one-way or two-way filtration features; the third woven fabric layer has a porous breathable structure configured to evaporate moisture from the second woven fabric layer;
the multi-layer fabric is intermittently bonded to form a plurality of bonded area and unbonded area; the plurality of bonded area and unbonded area are distributed in directions of length and width of the multi-layer fabric to cover a whole surface of the multi-layer fabric.

2. (canceled)

3. (canceled)

4. The biodegradable and ecofriendly fabric of claim 1, wherein the fabric further comprises a fourth woven fabric layer; where the fourth woven fabric layer provides a fourth characteristic or feature to the multi-layer fabric differing from the characteristics or features of the first woven fabric layer, the second woven fabric layer and the third woven fabric layer.

5. (canceled)

6. The biodegradable and ecofriendly fabric of claim 1, wherein the fabric is a multi-layer fabric and more than one layer of the fabric are bonded together into another multi-layer structure by quick and efficient ultrasonic heating or sealing in parts, in whole or in predesigned localized patterns.

7. The biodegradable and ecofriendly fabric of claim 1, wherein the fabric is a multilayer fabric, comprising 2-10 woven fabric layers.

8. The biodegradable and ecofriendly fabric of claim 1, used with or without ultrasonic heat bonding or sealing in parts, in whole or in predesigned localized patterns, as a woven membrane layer in place of non-woven or foam materials.

9. The biodegradable and ecofriendly fabric of claim 1, further used as one-way or two-way air and/or particle filtration media.

10. The biodegradable and ecofriendly fabric of claim 1, used as a pre-filter and/or a main filter and/or a post-filter; wherein any one or combinations of textured surface, controlled inter-yarns and intrafibers porosity of the fabric is dictated by particles and/or contaminants that is being filtered.

11. The biodegradable and ecofriendly fabric of claim 1, used as a woven membrane for moisture management and/or can be used as a woven membrane for moisture absorbency followed by moisture transport in products; the products comprise incontinence management products, sanitary products, wound dressings and bandages, compression garment, masks, textile apparels, carriers for wearable medical devices and products of the like kind.

12. (canceled)

13. The biodegradable and eco-friendly fabric of claim 1, wherein the moisture management characteristics are strengthened by multifunctional coatings, to shorten the life span of bacteria and viruses.

14. The biodegradable and ecofriendly fabric of claim 1, wherein a porosity and textured surface effect of the fabric are controlled and optimized to improve moisture management and breathability characteristics by a combination of fabric making techniques, and/or weaving structures, and/or manipulation of warp, and weft yarn filling patterns, and/or manipulation of warp yarn and weft yarn linear and thread densities into the fabric structure.

15. A method for making a biodegradable and ecofriendly fabric, comprising using a combination of PLA yarns, staple PLA yarns, filament PLA yarns or combinations of both yarns and/or PLA yarns as warp yarn, weft yarn or both to make the fabric; the fabric having one-way or two-way filtration characteristics, controlled porosity and textured surface;
the method further comprises:
employing any or a combination of twill satin and sateen, and/or dobby weave and/or manipulation of warp yarn filling patterns and/or weft yarn patterns and/or warp and/or weft linear densities and/or thread densities into the fabric structure;
employing any or a combination of centre-stitched, self-stitched, brocades, backed cloths, double cloth, treble cloths or interchanged fabric structure to produce intermittently integrated or continuously integrated fabric layers;
the fabric at least comprises a first woven fabric layer, a second woven fabric layer and a third woven fabric layer; the first woven fabric layer has wicking function, antimicrobial activity and liquid droplet or moisture vapors permeable structure; the second woven fabric layer is absorbent, and has quick dry and one-way or two-way filtration features; the third woven fabric layer has a porous breathable structure configured to evaporate moisture from the second woven fabric layer;
the multi-layer fabric is intermittently bonded to form a plurality of bonded area and unbonded area; the plurality of bonded area and unbonded area are distributed in directions of length and width of the multi-layer fabric to cover a whole surface of the multi-layer fabric.

16. (canceled)

17. (canceled)

18. The method for making a biodegradable and ecofriendly fabric of claim 15, comprising using weaving machines comprising shedding mechanism, warp supplies and weft insertion system; the shedding mechanism comprising tappet, dobby or Jacquard shedding mechanism; the warp supplies comprising single warp beam or twin warp beam; the weft insertion system comprising but not limited to air jet weft insertion system, projectile, rapier, shuttle, multiphase, water jet or magnetic weft insertion system.

19. The method for making a biodegradable and ecofriendly fabric of claim 15, comprising using weaving, braiding, weft knitting, warp knitting and non-woven technology.

20. The biodegradable and ecofriendly fabric of claim 1, wherein the fabric is made of staple PLA yarns with a yarn size 40's Ne, the fabric has a warp×weft thread density of 180×160.
